(19) United States
(12) Patent Application Publication
(10) Pub. No.: US 2024/0143931 A1
(43) Pub. Date: May 2, 2024

(54) CORRELATING INSTANCES OF WRITTEN FEEDBACK TO COMMON EVENTS IN TELEMETRY DATA

(71) Applicant: MICROSOFT TECHNOLOGY LICENSING, LLC, Redmond, WA (US)

(72) Inventors: Ryan Sung Jun BAE, Seattle, WA (US); Prachur BHARGAVA, Redmond, WA (US); Anjali S. PARIKH, Redmond, WA (US); Yijie WANG, Snoqualmie, WA (US); Sumit Siva DASAN, Redmond, WA (US)

(21) Appl. No.: 18/049,786

(22) Filed: Oct. 26, 2022

(51) Int. Cl. G06F 40/30; G06F 40/279; G06Q 30/02

(52) U.S. Cl. CPC G06F 40/30; G06F 40/279; G06Q 30/0282

(57) ABSTRACT

Disclosed herein is a system that automatically correlates related instances of written feedback associated with a computer product to relevant telemetry data so that a performance and/or reliability issue associated with the computer product can be identified and fixed in a more efficient manner. The system applies a natural language processing model to instances of written feedback that have been received for the computer product to identify a cluster of instances of written feedback which describe the same issue. For each instance of written feedback in the cluster, the system uses an identification and a timestamp to retrieve a telemetry event log. The system analyzes the telemetry event logs to identify a common telemetry event. This effectively correlates meaningful written descriptions with common telemetry behavior(s). Information regarding this correlation is provided to a computing device of a user (e.g., a developer) tasked with examining the performance and/or reliability issue.

### BACKGROUND

It is beneficial for manufacturers and/or developers of computer products (e.g., an operating system, an application, a network interface card) to receive written feedback describing experiences related to the use of the computer products on various types of computing devices (e.g., a laptop device, a desktop device, a tablet device, a smartphone device). For instance, users often provide written feedback describing a negative or frustrating experience (e.g., the user encounters a bug, a crash, a disabled or unavailable feature). Accordingly, manufacturers and/or developers of computer products typically establish a network-based mechanism through which users are able to share instances of written feedback (e.g., comments) that describe, in words, their experiences related to the use of the computer products. The users are typically customers who have purchased the computer product, or purchased a computing device on which the computer product is installed and/or executed.

It is also beneficial for manufacturers and/or developers of computer products to collect telemetry data useable to diagnose an issue (e.g., a problem) related to the performance and/or the reliability of the computer products. Telemetry data may alternatively be referred to as diagnostic data. Accordingly, in addition to the network-based mechanism through which users are able to share instances of written feedback, manufacturers and/or developers of computer products typically establish a separate network-based mechanism through which telemetry data associated with the computer products is collected. For instance, a computer product executing on a computing device can be configured to automatically report telemetry events. A telemetry event can characterize and/or identify specific types of errors, crashes, hangs, update failures, and so forth. The reporting of telemetry data can occur continuously (e.g., in real-time) or in association with a predetermined time interval (e.g., every minute, every hour, every day). Consequently, manufacturers and/or developers of computer products collect and analyze the telemetry data to discover performance and/or reliability issues. Moreover, the telemetry data can be used to provide developers with guidance for fixing the performance and/or reliability issues.

The manufacturers and/or developers of computer products do their best to manually parse through the instances of written feedback to identify performance and/or reliability issues in the computer product and/or efficient solutions to the performance and/or reliability issues. However, manually parsing through the instances of written feedback is a time-consuming task when a computer product is installed on tens of thousands, millions, or even billions of computing devices. For instance, a manufacturer of a globally used operating system recently received six million instances of written feedback related to the operating system in eighteen months, or an average of about three hundred and thirty-three thousand instances of written feedback per month. It is practically impossible for developers to parse through and read this voluminous amount of written feedback related to various performance and/or reliability issues that arise in a complex computer product such as an operating system.

Additionally, the manufacturers and/or developers of computer products separately analyze the collected telemetry data to identify performance and/or reliability issues in the computer product and/or efficient solutions to the performance and/or reliability issues. However, certain computer products are configured to generate and report a large number of telemetry events. Many of these telemetry events are irrelevant in that they do not help with the identification of the performance and/or reliability issues in the computer product and/or efficient solutions to the performance and/or reliability issues.

It is with respect to these and other considerations that the disclosure made herein is presented.

### SUMMARY

The techniques disclosed herein automatically correlate related instances of written feedback associated with a computer product to relevant telemetry data so that performance and/or reliability issues with the computer product can be identified and fixed in a more efficient manner. A computer product includes an instance of software, hardware, firmware, or a combination thereof, which can be installed on, and/or executed via, a computing device. For example, a computer product is an operating system, an application, a network interface card, and so forth.

Instances of written feedback typically frame the broader context of a performance and/or reliability issue (e.g., a crash, a hang, an update failure) in a way that the telemetry data cannot. This is because the instances of written feedback include descriptive words regarding the user experience with the computer product. The descriptive words make it easier for a developer tasked with examining a performance and/or reliability issue to understand the context of the user experience. In contrast, many of the telemetry events in telemetry data include complex error codes or bug numbers that are difficult for the developer tasked with examining the performance and/or reliability issue to easily understand when the complex error codes or the bug numbers are considered alone. However, the telemetry events, when understood, can be helpful to the developer because the error codes and/or the bug numbers provide more pointed guidance to an effective solution to the performance and/or reliability issue (e.g., a programming update that fixes the bug).

Accordingly, the system described herein is configured to correlate the broader context of the issue, as captured in the instances of the written feedback, with specific telemetry events that provide more pointed guidance to an effective solution to the performance and/or reliability issue. To do this, the system applies a natural language processing model to the instances of written feedback that have been received for a computer product. The application of the natural language processing model identifies instances of written feedback that are semantically similar. Stated alternatively, the application of the natural language processing model identifies instances of written feedback that are related in the sense that they describe the same or similar performance and/or reliability issue occurring within the computer product. Instances of written feedback that are semantically similar, or related, are referred to herein as a cluster of instances of written feedback. In one example, the process of applying the natural language processing model to identify a cluster of instances of written feedback is an unsupervised process. Thus, the model can be applied without needing manually assigned “training” labels for a set of instances of written feedback.

Once the system knows which instances of written feedback are semantically similar, or are related in the sense that they describe the same or similar performance and/or reliability issue, the system is configured to retrieve relevant telemetry event logs from the telemetry data. A telemetry event log is relevant because it includes telemetry events registered and/or reported by the computing device and/or the computer product around the time when a user submits an instance of written feedback describing a performance and/or reliability issue with the computer product. Accordingly, each instance of written feedback includes a timestamp that represents a time when the user submits the instance of written feedback. Moreover, each instance of written feedback includes an identification of the computing device and/or a specific instance of the computer product executing on the computing device.

For each instance of written feedback in a cluster, the system is configured to extract the timestamp and the identification. This extraction enables the system to retrieve a relevant telemetry event log from the telemetry data received from the identified computing device. For example, the system maps the identification associated with an instance of written feedback to corresponding telemetry data. Again, both the instance of written feedback and the telemetry data are received from the same computing device and/or in association with a specific instance of the computer product installed and/or executing on the computing device.

The system looks at the telemetry data and pulls telemetry events that occur within a predefined time window associated with the time the submission of the instance of written feedback occurs, as captured by the timestamp. In one example, the predefined time window is one week before the instance of written feedback is submitted. In another example, the predefined time window is twenty-four hours before the instance of written feedback is submitted. In yet another example, the predefined time window can be before and after the time when the instance of written feedback is submitted (e.g., one hour before and one hour after).

The system now has a cluster of instances of written feedback that describe the same or similar performance and/or reliability issue with a computer product, as well as corresponding telemetry event logs that are relevant because they include telemetry events for the computer product for which users submitted the instances of written feedback that have been clustered. The system analyzes the telemetry event logs to identify, or find, a common telemetry event. A common telemetry event is one that is found in more than one of the telemetry event logs. Accordingly, the system can determine a number of the telemetry event logs in which the common telemetry event is found.

Once the system has found a common telemetry event, the system identifies meaningful instances of written feedback in the cluster. A meaningful instance of written feedback is one that is received from the same computing device and/or instance of the computer product that reported the common telemetry event. This effectively links meaningful written descriptions with common telemetry behavior(s). The meaningful instances of written feedback from the cluster and the common telemetry event can then be provided to a computing device of a user (e.g., a developer) tasked with examining the performance and/or reliability issue with the computer product.

Being presented with both the instances of written feedback and the telemetry event(s) that are correlated to the instances of written feedback improves the efficiency of developers in understanding the performance and/or reliability issues and finding solutions to the performance and/or reliability issues (e.g., implementing a programming update to fix a bug). Consequently, the techniques described herein are able to link the context of customer pain points (e.g., a negative or frustrating experience described in words) to actionable telemetry events, which significantly reduces the manual labor involved in separately parsing and analyzing written feedback and telemetry data.

In various examples, the system can statistically quantify the significance of a correlation between a cluster of instances of written feedback and a common telemetry event, and use the statistical quantification as a basis for providing the meaningful instances of written feedback and the common telemetry event to the computing device of the user tasked with examining the performance and/or reliability issue with the product. The statistical quantification compares information associated with the common telemetry event within the cluster of instances of written feedback to information associated with the common telemetry event within the general population of computing devices for which telemetry data is reported and/or collected.

More specifically, the system is configured to calculate a first hit ratio based on the number of the telemetry event logs retrieved for the cluster of instances of written feedback in which the common telemetry event is found and a total number of the telemetry event logs retrieved for the cluster of instances of written feedback. Stated alternatively, the system first focuses on the cluster and determines a percentage of computing devices in the cluster that registered and/or reported the common telemetry event.

The system is also configured to calculate a second hit ratio based on a number of computing devices that have reported telemetry data in which the common telemetry event is found and a total number of computing devices that have reported telemetry data. Stated alternatively, this second hit ratio represents a percentage at which the common telemetry event is registered and/or reported in the general population of computing devices for which telemetry data is collected.

Next, the system compares the first hit ratio to the second hit ratio to determine a difference value, and determines whether the difference value is greater than a threshold difference value. The system establishes the threshold difference value to represent a degree of confidence in the correlation between the common telemetry event and the cluster of instances of written feedback. For example, if the difference value is close to zero, and thus is not greater than the threshold difference value, the system determines there is no meaningful correlation between the common telemetry event and the written instances of feedback in the cluster because the common telemetry event is found in roughly the same proportion of computing devices when looking at the general population of computing devices. In contrast, if the difference value is large, and thus is greater than the threshold difference value, the system determines there is a meaningful correlation between the common telemetry event and the written instances of feedback in the cluster because the proportion of computing devices in which the common telemetry event is found in the cluster is significantly greater than the proportion of computing devices in which the common telemetry event is found when looking at the general population of computing devices.

This Summary is provided to introduce a selection of concepts in a simplified form that are further described below in the Detailed Description. This Summary is not intended to identify key or essential features of the claimed subject matter, nor is it intended to be used as an aid in determining the scope of the claimed subject matter. The term “techniques,” for instance, may refer to system(s), method(s), computer-readable instructions, module(s), algorithms, hardware logic, and/or operation(s) as permitted by the context described above and throughout the document.

### BRIEF DESCRIPTION OF THE DRAWINGS

The Detailed Description is described with reference to the accompanying figures. In the figures, the left-most digit(s) of a reference number identifies the figure in which the reference number first appears. The same reference numbers in different figures indicate similar or identical items. References made to individual items of a plurality of items can use a reference number with a letter of a sequence of letters to refer to each individual item. Generic references to the items may use the specific reference number without the sequence of letters.

FIG. 1 is a diagram illustrating an example environment in which a system automatically correlates related instances of written feedback associated with a computer product to relevant telemetry data so that performance and/or reliability issues with the computer product can be identified and fixed in a more efficient manner.

FIG. 2 is a block diagram illustrating application of a natural language processing model to identify a cluster of related instances of written feedback from which identifications and timestamps useable to retrieve relevant telemetry event logs can be extracted.

FIG. 3 is a block diagram illustrating the retrieval of telemetry event logs from the collected telemetry data based on the identifications and timestamps extracted from the instances of written feedback in the cluster of related instances of written feedback, as well as the analysis of the retrieved telemetry event logs to identify a common telemetry event in the cluster.

FIG. 4 is a block diagram illustrating an example significance test applied to a correlation between the cluster of related instances of written feedback and the common telemetry event, to determine whether the system is confident in the correlation (e.g., the correlation is significant).

FIG. 5 is an example graphical user interface illustrating information describing correlation(s) between common telemetry event(s) and the cluster of related instances of written feedback.

FIG. 6 is a flow diagram of an example method for identifying a common telemetry event that is found in telemetry event logs retrieved for a cluster of related instances of written feedback.

FIG. 7 is a flow diagram of an example method for determining whether the common telemetry event is significant for examining purposes.

FIG. 8 is a computer architecture diagram showing an illustrative computer hardware and software architecture for a computing device that can implement aspects of the technologies presented herein.

### DETAILED DESCRIPTION

The following Detailed Description discloses techniques for automatically correlating related instances of written feedback associated with a computer product to relevant telemetry data so that a performance and/or reliability issue with the computer product can be identified and fixed in a more efficient manner. The system applies a natural language processing model to instances of written feedback that have been received for the computer product to identify a cluster of instances of written feedback which describe the same or similar performance and/or reliability issue. For each instance of written feedback in the cluster, the system uses an identification and a timestamp to retrieve a telemetry event log. The system analyzes the telemetry event logs to identify a common telemetry event. This effectively correlates meaningful written descriptions with common telemetry behavior(s). Information regarding this correlation is provided to a computing device of a user (e.g., a developer) tasked with examining the performance and/or reliability issue.

Being presented with both the instances of written feedback and the telemetry event(s) that are correlated to the instances of written feedback improves the efficiency of developers in understanding the performance and/or reliability issues and finding solutions to the performance and/or reliability issues (e.g., implementing a programming update to fix a bug). Consequently, the techniques described herein are able to link the context of customer pain points (e.g., a negative or frustrating experience described in words) to actionable telemetry events, which significantly reduces the manual labor involved in separately parsing and analyzing written feedback and telemetry data. Furthermore, the retrieval of relevant telemetry event logs, which include telemetry events that are temporally associated with a time when an instance of written feedback is submitted, limits the amount of telemetry data that needs to be analyzed. In turn, this reduces the processing and/or storage resources required to perform the analysis.

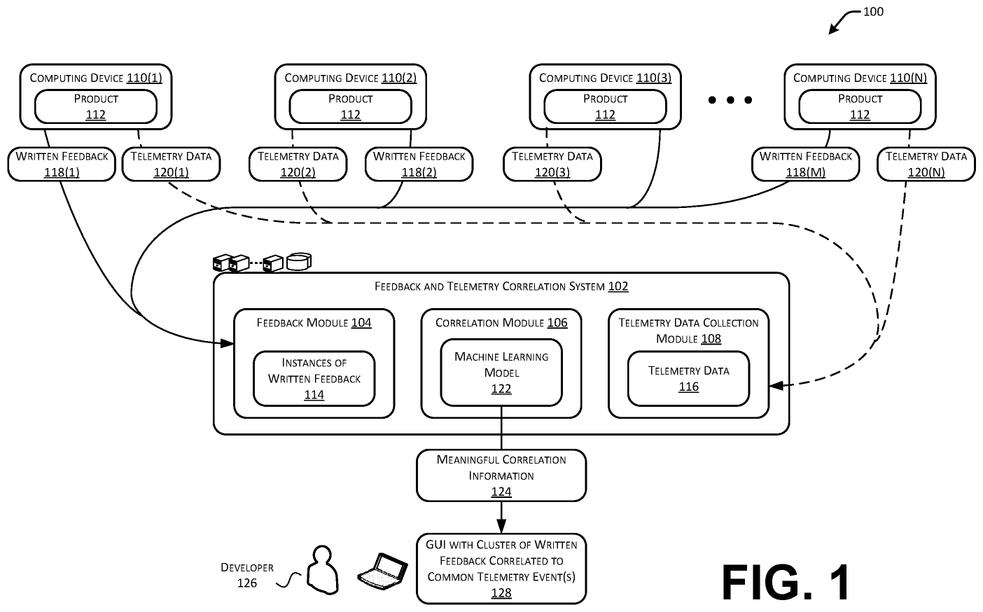

Various examples, scenarios, and aspects for correlating related instances of written feedback associated with a computer product to relevant telemetry data so that a performance and/or reliability issue with the computer product can be identified and fixed in a more efficient manner, are described below with reference to FIGS. 1-8.

FIG. 1 is a diagram illustrating an example environment 100 in which a feedback and telemetry correlation system 102 (may be referred to herein as a system 102) is configured to correlate a cluster of related instances of written feedback to relevant telemetry data so that performance and/or reliability issues with the computer product can be identified and fixed in a more efficient manner. The system 102 includes a feedback module 104, a correlation module 106, and a telemetry data collection module 108. The number of illustrated modules is just an example, and the number can vary higher or lower. That is, functionality described herein in association with the illustrated modules can be performed by a fewer number of modules or a larger number of modules on one device or spread across multiple devices. Further, the system 102 can include one or more computing devices (e.g., servers) that operate in a cluster or other grouped configuration to share resources, balance load, increase performance, provide fail-over support or redundancy, or for other purposes.

The system 102 is configured to operate on information received and/or collected from client computing devices 110(1-N) on which a computer product 112 is installed and executed. For example, the computer product 112 can be an operating system (e.g., GOOGLE ANDROID, APPLE IOS or MACOS, MICROSOFT WINDOWS), an application (e.g., a word processing application, a gaming application, a streaming application, a banking application, an electronic commerce application, a videoconferencing application), a network interface card, or other types of software, hardware, and/or firmware components. To this end, the client computing devices 110(1-N) can be the same type of computing device or different types of computing devices (e.g., a server device, a desktop device, a laptop device, a tablet device, a smartphone device, a smartwatch device, a head-mounted display device, an Internet of Things (IoT) device). In most examples, the number N is a large number in the thousands, hundreds of thousands, millions, hundreds of millions, or even billions.

The information associated with the computer product 112 received and/or collected by the system 102 includes instances of written feedback 114 and telemetry data 116. For example, the feedback module 104 is configured to receive instances of written feedback 118(1-M) from the client computing devices 110(1-N). In one example, an instance of written feedback 118(1-M) includes a comment, authored by a user of the computer product 112, that describes a frustrating experience caused by a performance and/or reliability issue related to the computer product 112 (e.g., a bug, a crash, a hang, an update failure) in words. Thus, the feedback module 104 can be a mechanism established by a manufacturer and/or developer of the computer product 112 to elicit feedback that can be analyzed so the reliability and/or performance of the computer product 112 can be improved. The number M is typically smaller than the number N because not all users of the client computing devices 110(1-N) and the computer product 112 encounter frustrating experiences. For instance, the frustrating experience may relate to a specific feature with which not all users interact. Even further, not all users of the client computing devices 110(1-N) and the computer product 112 that encounter a frustrating experience take the time to write and submit an instance of written feedback (e.g., FIG. 1 illustrates that the feedback module 104 does not receive an instance of written feedback from computing device 110(3)).

The feedback module 104 can be configured to implement privacy-preserving practices. For example, user information associated with the instances of written feedback 118(1-M) can be obfuscated. In another example, the instances of written feedback 118(1-M) can be deleted after a threshold period of time.

The telemetry data collection module 108 is configured to collect telemetry data 120(1-N) from the client computing device 110(1-N). As described above, the telemetry data 120(1-N) includes telemetry events that capture various performance and/or reliability issues, such as bugs, crashes, hangs, update failures, or other types of errors. Thus, the telemetry data 120(1-N) provides insightful, error-based information for a developer to act upon. Accordingly, the telemetry data collection module 108 can be a mechanism established by a manufacturer and/or developer of the computer product 112 to monitor and/or track telemetry events related to the execution and/or performance of the computer product 112.

The telemetry data collection module 108 can also be configured to implement privacy-preserving practices. For example, users can provide input that enables and/or disables the collection of telemetry data 120(1-N) from their instances of the computer product 112 (e.g., the user can opt in to the collection and/or opt out of the collection). In another example, the instances of telemetry data 120(1-N) can be deleted after a threshold period of time.

It is noted that while the example environment 100 of FIG. 1 illustrates that the feedback module 104 and the telemetry data collection module 108 are part of the system 102, the feedback module 104 and/or the telemetry data collection module 108 can alternatively be part of a different system (e.g., a system dedicated to receiving customer feedback, a system dedicated to collecting telemetry data). Accordingly, the correlation module 106 is configured to access the instances of written feedback 114 and the telemetry data 116 in order to apply a machine learning model 122, as further described herein.

The client computing devices 110(1-N) can include network interface(s) to enable communications to the system 102 over network(s). Such network interface(s) can include network interface controllers (NICs) or other types of transceiver devices to send and receive communications and/or data over a network. Network(s) can include, for example, public networks such as the Internet, private networks such as an institutional and/or personal intranet, or some combination of private and public networks. Network(s) can also include any type of wired and/or wireless network, including but not limited to local area networks (LANs), wide area networks (WANs), satellite networks, cable networks, Wi-Fi networks, WiMax networks, mobile communications networks (e.g., 3G, 4G, 5G, and so forth) or any combination thereof. Network(s) can utilize communications protocols, including packet-based and/or datagram-based protocols such as internet protocol (IP), transmission control protocol (TCP), user datagram protocol (UDP), or other types of protocols.

As described above, instances of written feedback 114 typically frame the broader context of a performance and/or reliability issue in a way that the telemetry data 116 cannot. This is because the instances of written feedback 114 include descriptive words regarding the user experience with the computer product 112. The descriptive words make it easier for a developer tasked with examining a performance and/or reliability issue to understand the context of the user experience. In contrast, many of the telemetry events in telemetry data 116 include complex error codes or bug numbers that are difficult for the developer tasked with examining the performance and/or reliability issue to easily understand. However, the telemetry events, when understood, can be helpful to the developer because the error codes and/or the bug numbers provide more pointed guidance to an effective solution to the performance and/or reliability issue (e.g., a programming update that fixes the bug).

Many issues related to the reliability and/or performance of the computer product 112, as described in the instances of written feedback, are typically unanswered and/or unresolved due to the lack of corresponding telemetry data. The correlation module 106 solves this problem by accessing the instances of written feedback 114 (e.g., instances of written feedback 118(1-M)) and the telemetry data 116, and applying a machine learning model 122 to produce meaningful correlation information 124 associated with a performance and/or reliability issue. The meaningful correlation information 124 links a cluster of instances of written feedback that describe the same or similar performance and/or reliability issue to a common telemetry event that likely caused the performance and/or reliability issue, as further described herein.

FIG. 1 illustrates that the meaningful correlation information 124 is provided to a user tasked with examining the performance and/or reliability issue. For instance, the user is a developer 126 and the meaningful correlation information 124 can be displayed to the developer 126 via a graphical user interface (GUI) 128 that correlates the cluster of instances of written feedback that describe the performance and/or reliability issue to the common telemetry event that likely caused, or at least contributed to, the performance and/or reliability issue.

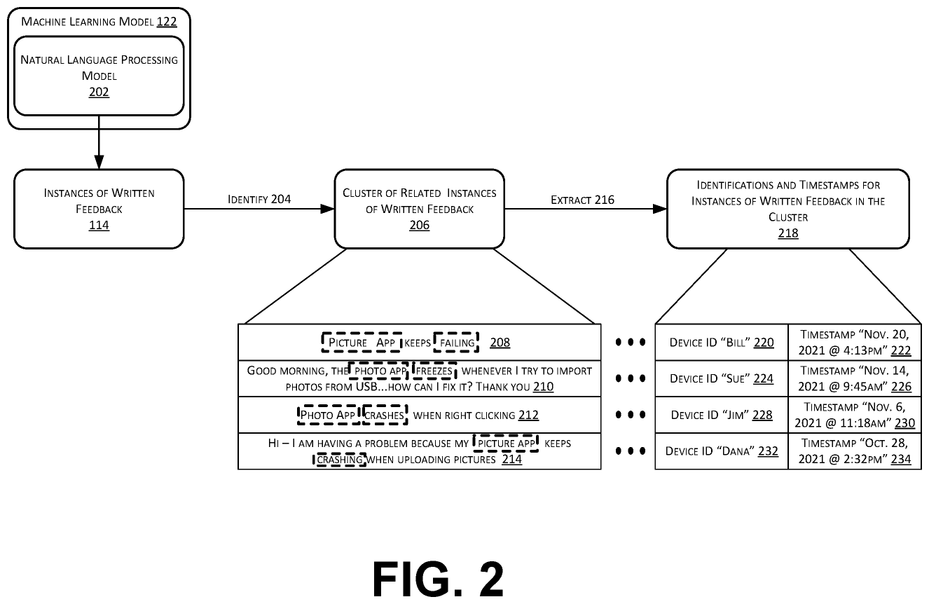

As illustrated in FIG. 2, the machine learning model 122 of FIG. 1 includes a natural language processing model 202. The correlation module 106 applies the natural language processing model 202 to the instances of written feedback 114 that have been received for the computer product 112 and/or accessed by the correlation module 106. In one example, the instances of written feedback 114 to which the natural language processing model 202 is applied are limited to ones that are recently received (e.g., received in the last twenty-four hours, received in the last week, received in the last month, received in the last year).

The application of the natural language processing model 202 identifies 204 instances of written feedback that are related in the sense that they describe the same or similar performance and/or reliability issue occurring within the computer product 112. Instances of written feedback that are related are referred to herein as a cluster of instances of written feedback 206. To identify 204 the cluster of related instances of written feedback 206, the natural language processing model 202 performs feature extraction on the instances of written feedback 114. The features can include words typically used to describe a performance and/or reliability issue. Moreover, the feature extraction is able to distinguish between less important words and more important words that provide a more meaningful contribution to the semantics of a phrase (e.g., a sentence, a comment).

Accordingly, in one example, the natural language processing model 202 produces a vector space that includes a vector representation for the words (e.g., a word embedding) used in an individual instance of written feedback. The vector representations are positioned in the vector space such that instances of written feedback that are more likely to share common linguistic contexts are located in close proximity to one another. The natural language processing model 202 uses vector representations that share a linguistic context, and thus are semantically similar, to identify 204 the cluster of related instances of written feedback 206. The use of the natural language processing model 202 accounts for the variation in length (e.g., number of words) and/or word quality of the instances of written feedback.

As shown in FIG. 2, the natural language processing model 202 identifies a cluster of related instances of written feedback 206 that includes four comments 208, 210, 212, 214 related to an application that is part of an operating system. A first comment 208 states “Picture app keeps failing”. A second comment 210 states “Good morning, the photo app freezes whenever I try to import photos from USB . . . how can I fix it? Thank you”. A third comment 212 states “Photo app crashes when right clicking”. A fourth comment 214 states “Hi—I am having a problem because my picture app keeps crashing when uploading pictures”. As captured by the dash lined boxes, each of the comments 208, 210, 212, 214 includes words determined to share a linguistic context, e.g., related to a performance and/or reliability issue (e.g., crash, freeze, failing) with the photo/picture application of an operating system.

In one example, the natural language processing model 202 is an unsupervised model (e.g., FASTTEXT developed by FACEBOOK) that is computationally efficient because the model can be applied without needing manually assigned “training” labels for the written feedback. The natural language processing model 202 can initially be trained to learn the vocabulary that is typically used when customers provide feedback for a particular computer product 112. Furthermore, the natural language processing model 202 can continue to be trained each time the correlation process is executed on a new set of instances of written feedback.

Next, the correlation module 106 extracts 216, for each instance of written feedback in the cluster 206, identifications and timestamps 218. Accordingly, each instance of written feedback includes a timestamp that represents a time when a user submits the instance of written feedback. Moreover, each instance of written feedback includes an identification of the client computing device (e.g., a user account for the device) and/or an instance of the computer product executing on the client computing device (e.g., a user account for the computer product 112). As shown in FIG. 2, comment 208 is received from device ID “Bill” 220 and is represented by the timestamp of “Nov. 20, 2021 at 4:13 PM” 222. Comment 210 is received from device ID “Sue” 224 and is represented by the timestamp of “Nov. 14, 2021 at 9:45 AM” 226. Comment 212 is received from device ID “Jim” 228 and is represented by the timestamp of “Nov. 6, 2021 at 11:18 AM” 230. Comment 214 is received from device ID “Dana” 232 and is represented by the timestamp of “Oct. 28, 2021 at 2:32 PM” 234.

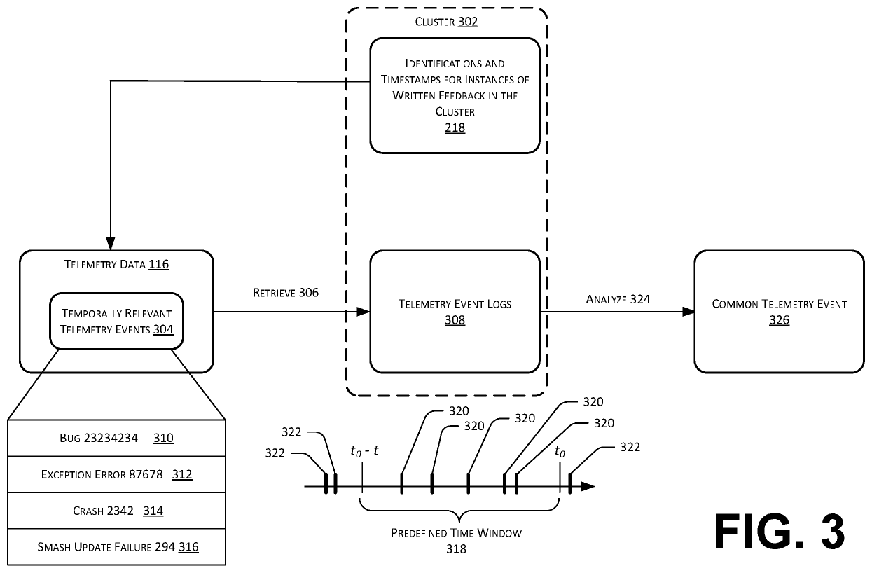

This extraction 216 of the identifications and timestamps 218 enables the correlation module 106 to retrieve a relevant telemetry event log from the telemetry data received from the identified client computing device, as described in FIG. 3. As shown, the cluster 302 in FIG. 3 starts with identifications (e.g., a device identification, an account identification, a user identification) and timestamps 218 associated with instances of written feedback in the cluster 206.

For each instance of written feedback in the cluster 302, the correlation module 106 maps the identification to a corresponding (e.g., matching) identification in the telemetry data 116. As described above, both the instance of written feedback and the telemetry data are received from the same client computing device and/or in association with an instance of the computer product installed and/or executing on the client computing device.

The correlation module 106 then uses the timestamp to identify telemetry events 304 that are temporally relevant to the time at which the instance of written feedback is submitted. Stated alternatively, the correlation module 106 identifies telemetry events that occur around the same time at which the instance of written feedback is submitted. Thus, the correlation module 106 is configured to retrieve 306 a relevant telemetry event log 308 for each instance of written feedback in the cluster 302. The telemetry event log 308 includes the telemetry events 304 that are temporally relevant to the time at which the instance of written feedback is submitted.

As shown in FIG. 3, a telemetry event included in a telemetry event log 308 can include specific identifiers or codes for various events, such as “Bug 23234234” 310, “Exception Error 87678” 312, “Crash 2342” 314, and “Smash Update Failure 294” 316. As described above, these specific identifiers or codes are difficult for a developer tasked with examining a performance and/or reliability issue to understand when considered alone.

In one example, a telemetry event is identified as a temporally relevant event 304 to be included in the retrieved telemetry event log 308 if the telemetry event occurs within a predefined time window t 318 (e.g., twenty-four hours, three days, one week, one month) associated with the timestamp that represents the time at which an instance of written feedback is submitted. As shown in FIG. 3, the timestamp associated with an instance of written feedback is represented by to, and the predefined time window 318 includes telemetry events 320 that occur within a time period from t₀−t to t₀ (e.g., a time period before the instance of written feedback is submitted). In contrast, telemetry events 322 that occur outside the predefined time window 318 are not determined to be temporally relevant, and therefore, are not included in the retrieved telemetry event logs 308. While the example predefined time window 318 in FIG. 3 is a time period before the timestamp t₀, it is understood in the context of this disclosure that the predefined time window can alternatively be before and after the timestamp to (e.g., one hour before and one hour after).

Now the cluster 302 further includes the telemetry event logs 308 associated with the related instances of written feedback. Next, the correlation module 106 analyzes 324 the telemetry event logs 308 to identify a common telemetry event 326. A common telemetry event 326 is one that is found in more than one of the telemetry event logs 308. Accordingly, the common telemetry event 326 serves as a correlation signal between the registered and reported diagnostics of the computer product 112 and the cluster of related instances of written feedback 206. The correlation module 106 determines a number of the telemetry event logs 308 in which the common telemetry event 326 is found.

Now that the correlation module 106 has identified the common telemetry event 326, the correlation module 106 identifies meaningful instances of written feedback in the cluster 302. A meaningful instance of written feedback is one that is received from the same computing device and/or instance of the computer product that reported the common telemetry event 326. This effectively links meaningful written descriptions with common telemetry behavior(s). The meaningful instances of written feedback from the cluster 302 and the common telemetry event 326 can then be provided to a user (e.g., a developer 126) tasked with examining the performance and/or reliability issue with the computer product 112 via the GUI 128 illustrated in FIG. 1.

Being presented with both the instances of written feedback and the telemetry event(s) that are correlated to the instances of written feedback improves the efficiency of developers in understanding the performance and/or reliability issues and finding solutions to the performance and/or reliability issues (e.g., implementing a programming update to fix a bug). Consequently, the techniques described herein are able to link the context of customer pain points (e.g., a negative or frustrating experience described in words) to actionable telemetry events, which significantly reduces the manual labor involved in separately parsing and analyzing written feedback and telemetry data.

In various examples, the correlation module 106 is configured to statistically quantify the significance of a correlation between a cluster of instances of written feedback 206, 302 and a common telemetry event 326, and use the statistical quantification as a basis for providing the meaningful instances of written feedback and the common telemetry event to the computing device of the user tasked with examining the performance and/or reliability issue with the product. The statistical quantification compares information associated with the common telemetry event 326 within the cluster of instances of written feedback 206, 302 to information associated with the common telemetry event 326 within the general population of client computing devices 110(1-N) for which telemetry data 120(1-N) is reported and/or collected by the telemetry data collection module 108.

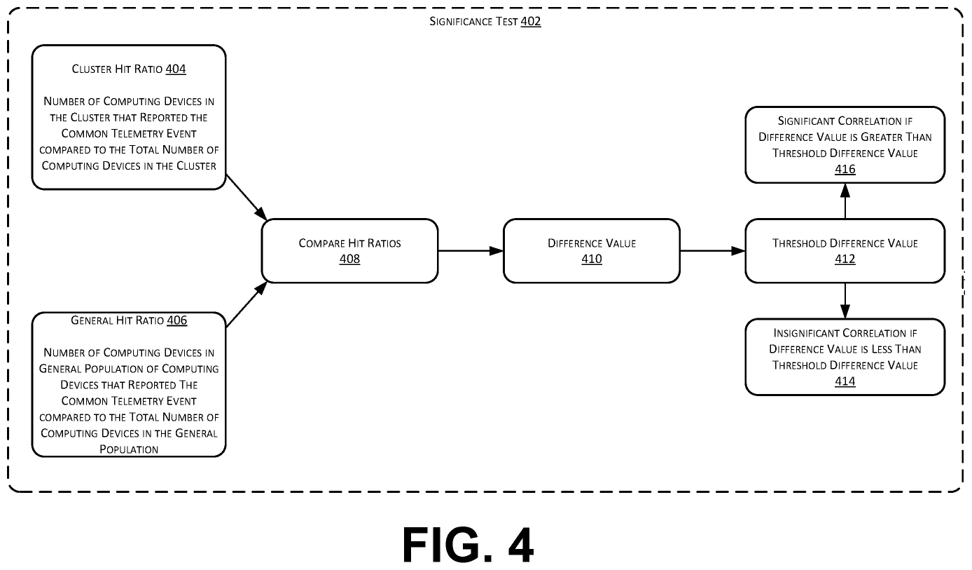

FIG. 4 is a block diagram illustrating an example significance test 402 applied to a determined correlation between the cluster of related instances of written feedback and the common telemetry event 326. The significance test 402 determines whether the correlation module 106 is confident in the determined correlation.

As illustrated, the correlation module 106 is configured to calculate a first hit ratio, referred to in FIG. 4 as a cluster hit ratio 404. The cluster hit ratio 404 is calculated based on the number of the telemetry event logs 308 retrieved for the cluster 206, 302 of instances of written feedback in which the common telemetry event 326 is found and a total number of the telemetry event logs 308 retrieved for the cluster of instances of written feedback. Stated alternatively, the cluster hit ratio 404 focuses on the cluster 206, 302, and determines a percentage of computing devices in the cluster 206, 302 that registered and/or reported the common telemetry event 326.

The correlation module 106 is also configured to calculate a second hit ratio, referred to in FIG. 4 as a general hit ratio 406. The general hit ratio 406 is based on a number of the client computing devices 110(1-N) that have reported telemetry data 120(1-N) in which the common telemetry event 326 is found and a total number of the client computing devices 110(1-N) that have reported telemetry data 120(1-N). Stated alternatively, the general hit ratio 406 represents a percentage at which the common telemetry event 326 is registered and/or reported in the general population of client computing devices for which telemetry data is collected.

Next, the correlation module 106 compares 408 the cluster hit ratio 404 to the general hit ratio 406 to determine a difference value 410. The correlation module 106 then determines whether the difference value 410 is greater than a threshold difference value 412. The correlation module 106 establishes the threshold difference value 412 to represent a degree of confidence in the correlation between the common telemetry event 326 and the cluster of instances of written feedback 206, 302. For example, when using percentages or normalized values between zero and one, if the difference value 410 is zero or small (e.g., 0, 0.10, 0.20, 0.30), the correlation module 106 determines there is no significant (e.g., insignificant) correlation 414 between the common telemetry event 326 and the written instances of feedback in the cluster 206, 302 because the common telemetry event is found in roughly the same proportion of client computing devices when looking at the general population of client computing devices. In contrast, if the difference value is large (e.g., 0.60, 0.70, 0.90), the correlation module 106 determines there is a significant correlation 416 between the common telemetry event 326 and the written instances of feedback in the cluster 206, 302 because the proportion of client computing devices in which the common telemetry event is found in the cluster 206, 302 is significantly greater than the proportion of client computing devices in which the common telemetry event is found when looking at the general population of client computing devices. Consequently, the threshold difference value 412 (e.g., 0.50) is established by the correlation module 106 to distinguish between insignificant correlations (e.g., small difference values) and significant correlations (e.g., large difference values).

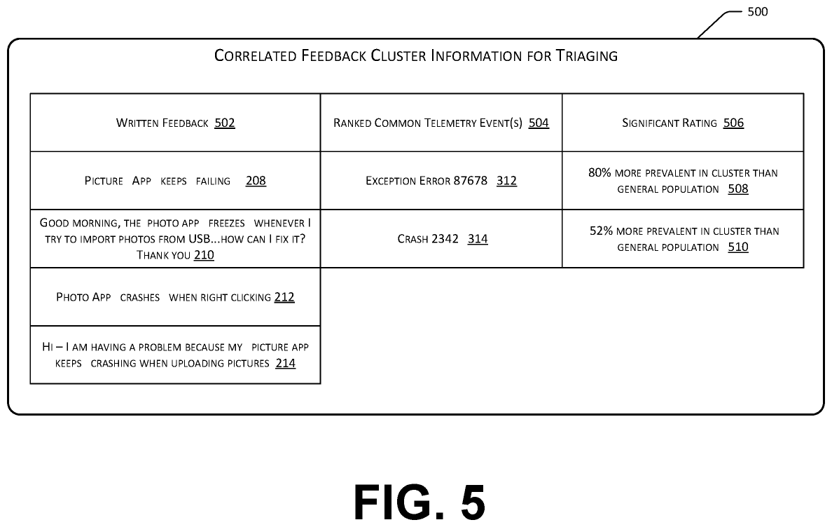

If the correlation module 106 identifies more than one common telemetry event 326, the correlation module 106 can rank the common telemetry events 326 found in a cluster 206, 302 according to their difference values 410. FIG. 5 is an example GUI 500 illustrating information describing correlation(s) between common telemetry event(s) and the cluster of related instances of written feedback. The GUI 500 can be presented to a developer 126 tasked with examining a performance and/or reliability issue. The GUI 500 includes an area where the meaningful instances of written feedback 502 are displayed, an area where the common telemetry event(s) 504 are displayed (e.g., in ranked order), and an area where the significant ratings 506 (e.g., the difference values 410) are displayed.

The instances of written feedback 502 and the common telemetry events 504 included in the GUI 500 are the ones illustrated in FIG. 2 and FIG. 3. Accordingly, the telemetry event “Exception Error 87678” 312 and the telemetry event “Crash 2342” 314 were found for each of the computing devices and/or users that submitted the displayed instances of written feedback 208, 210, 212, 214. Moreover, the telemetry event “Exception Error 87678” 312 was found to be eighty percent more prevalent in the cluster compared to the general population of client computing devices 508. For instance, the telemetry event “Exception Error 87678” may have been found in ninety percent of the cluster and only ten percent of the general population of client computing devices. The telemetry event “Crash 2342” 314 was found to be fifty-two more prevalent in the cluster compared to the general population 510. For instance, the telemetry event “Crash 2342” 314 may have been found in seventy-eight percent of the cluster and only twenty-six percent of the general population of computing devices. As shown, the correlation module 106 can generate a GUI 500 that presents the more prominent observed telemetry events in a cluster and links the more prominently observed telemetry events to written feedback.

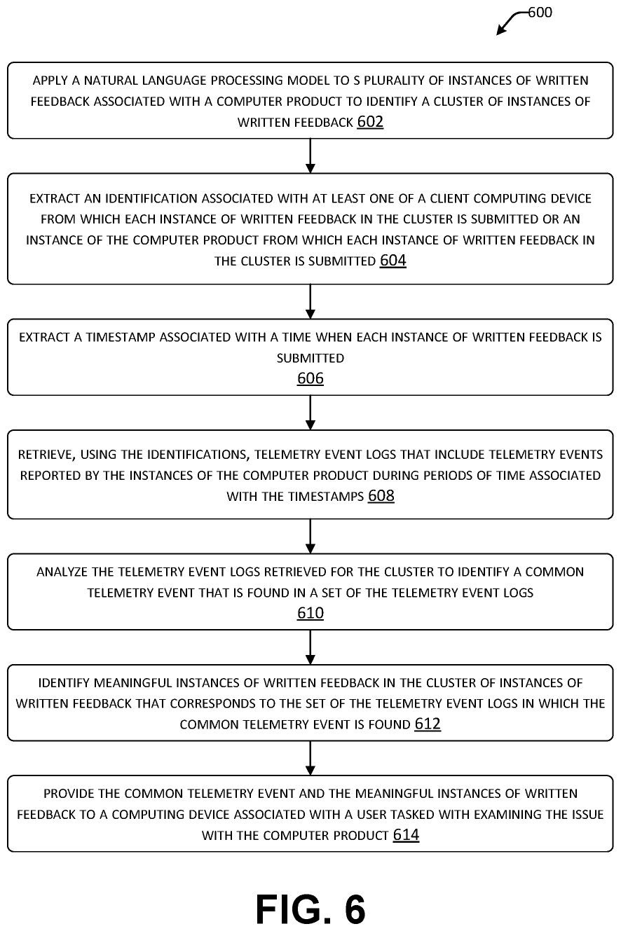

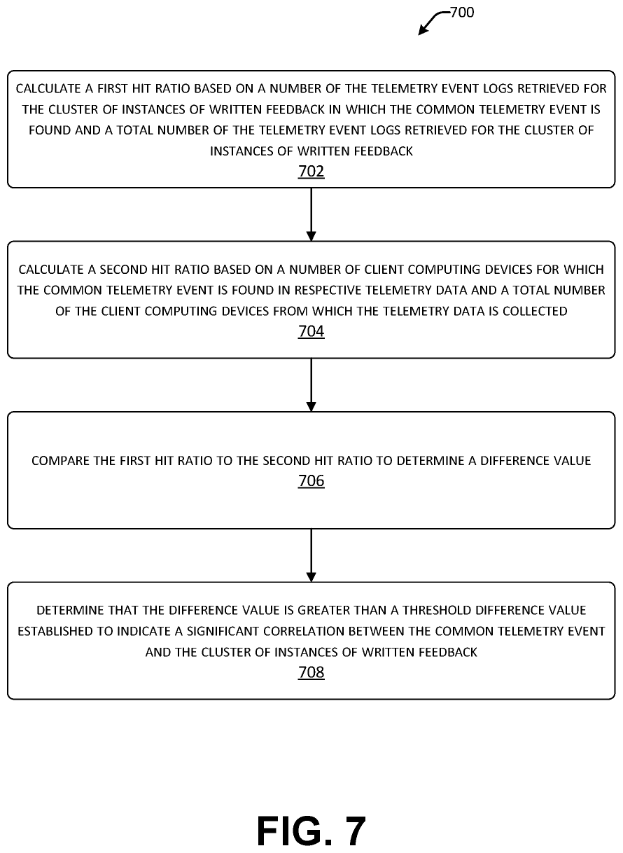

FIGS. 6 and 7 represent example processes in accordance with various examples from the description of FIGS. 1-5. The example operations shown in FIGS. 6 and 7 can be implemented on or otherwise embodied in one or more device(s) of the system 102.

The order in which the operations are described is not intended to be construed as a limitation, and any number of the described operations can be combined in any order and/or in parallel to implement each process. Moreover, the operations in FIGS. 6 and 7 can be implemented in hardware, software, and/or a combination thereof. In the context of software, the operations represent computer-executable instructions that, when executed by one or more processing units, cause one or more processing units to perform the recited operations. For example, modules and other components described herein can be stored in a computer-readable media and executed by at least one processing unit to perform the described operations.

FIG. 6 is a flow diagram of an example method 600 for identifying a common telemetry event that is found in telemetry event logs retrieved for a cluster of related instances of written feedback.

At operation 602, a natural language processing model is applied to a plurality of instances of written feedback associated with a computer product to identify a cluster of instances of written feedback. Consequently, the instances of written feedback in the cluster are semantically similar and the cluster is associated with a performance and/or reliability issue with the computer product.

At operation 604, an identification associated with at least one of a client computing device from which each instance of written feedback in the cluster is submitted or an instance of the computer product from which each instance of written feedback in the cluster is submitted is extracted.

At operation 606, a timestamp associated with a time when each instance of written feedback in the cluster is submitted is extracted.

At operation 608, the identifications are used to retrieve telemetry event logs that include telemetry events reported by the instances of the computer product during periods of time associated with the timestamps.

At operation 610, the telemetry event logs retrieved for the cluster of instances of written feedback are analyzed to identify a common telemetry event that is found in a number of the telemetry event logs.

At operation 612, a number of meaningful instances of written feedback in the cluster of instances of written feedback that corresponds to the number of the telemetry event logs in which the common telemetry event is found is identified.

At operation 614, the common telemetry event and the number of meaningful instances of written feedback are provided to a computing device associated with a user tasked with examining the performance and/or reliability issue with the computer product.

FIG. 7 is a flow diagram of an example method 700 for determining whether the common telemetry event is significant for examining purposes.

At operation 702, a first hit ratio is calculated. The first hit ratio is based on the number of the telemetry event logs retrieved for the cluster of instances of written feedback in which the common telemetry event is found and a total number of the telemetry event logs retrieved for the cluster of instances of written feedback.

At operation 704, a second hit ratio is calculated. The second hit ratio is based on a number of client computing devices for which the common telemetry event is found in respective telemetry data and a total number of the client computing devices from which the telemetry data is collected.

At operation 706, the first hit ratio is compared to the second hit ratio to determine a difference value.

At operation 708, the difference value is determined to be greater than a threshold difference value established to indicate a significant correlation between the common telemetry event and the cluster of instances of written feedback. Accordingly, the common telemetry event and the number of meaningful instances of written feedback are provided (e.g., to a develop for examining purposes) in response to determining that the difference value is greater than the threshold difference value.

The method of FIG. 7 can be repeated for each common telemetry event found for a cluster of instances of written feedback. Consequently, the techniques described herein can provide a group of written comments with a set of common telemetry events which are ranked based on their difference values.

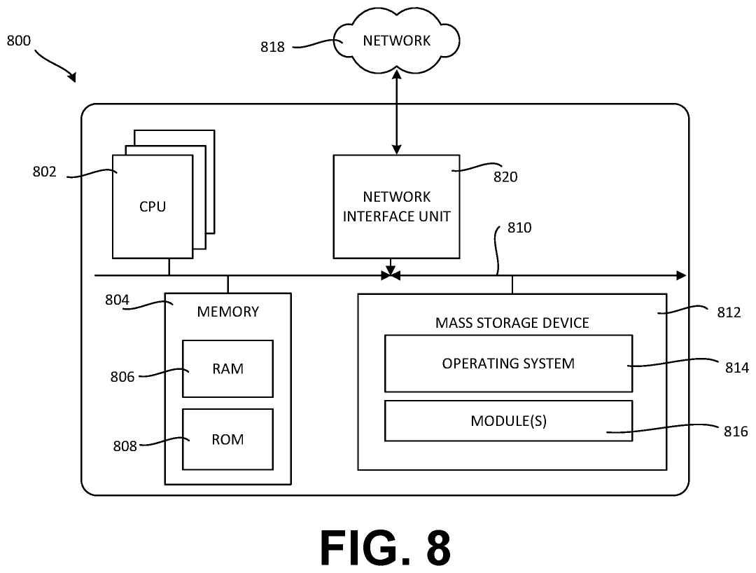

FIG. 8 is a computer architecture diagram showing an illustrative computer hardware and software architecture for a computing device that can implement the various technologies presented herein. In particular, the architecture illustrated in FIG. 8 can be utilized to implement a server or other type of computing device capable of implement the modules of the system 102 in FIG. 1.

The computing device 800 illustrated in FIG. 8 includes a central processing unit 802 (“CPU”), a system memory 804, including a random-access memory 806 (“RAM”) and a read-only memory (“ROM”) 808, and a system bus 810 that couples the memory 804 to the CPU 802. A basic input/output system (“BIOS” or “firmware”) containing the basic routines that help to transfer information between elements within the computing device 800, such as during startup, can be stored in the ROM 808. The computing device 800 further includes a mass storage device 812 for storing an operating system 814, application programs, and/or other types of programs. The mass storage device 812 can also be configured to store other types of programs and data, such as modules 816 (e.g., the modules illustrated in FIG. 1).

The mass storage device 812 is connected to the CPU 802 through a mass storage controller connected to the bus 810. The mass storage device 812 and its associated computer readable media provide non-volatile storage for the computing device 800. Although the description of computer readable media contained herein refers to a mass storage device, such as a hard disk, CD-ROM drive, DVD-ROM drive, or USB storage key, it should be appreciated by those skilled in the art that computer readable media can be any available computer storage media or communication media that can be accessed by the computing device 800.

Communication media includes computer readable instructions, data structures, program modules, or other data in a modulated data signal such as a carrier wave or other transport mechanism and includes any delivery media. The term “modulated data signal” means a signal that has one or more of its characteristics changed or set in a manner so as to encode information in the signal. By way of example, and not limitation, communication media includes wired media such as a wired network or direct-wired connection, and wireless media such as acoustic, radio frequency, infrared and other wireless media. Combinations of the any of the above should also be included within the scope of computer readable media.

By way of example, and not limitation, computer storage media can include volatile and non-volatile, removable and non-removable media implemented in any method or technology for storage of information such as computer readable instructions, data structures, program modules or other data. For example, computer storage media includes, but is not limited to, RAM, ROM, EPROM, EEPROM, flash memory or other solid-state memory technology, CD-ROM, digital versatile disks (“DVD”), HD-DVD, BLU-RAY, or other optical storage, magnetic cassettes, magnetic tape, magnetic disk storage or other magnetic storage devices, or any other medium that can be used to store the desired information and which can be accessed by the computing device 800. For purposes of the claims, the phrase “computer storage medium,” and variations thereof, does not include waves or signals per se or communication media.

According to various configurations, the computing device 800 can operate in a networked environment using logical connections to remote computers through a network such as the network 818. The computing device 800 can connect to the network 818 through a network interface unit 820 connected to the bus 810. It should be appreciated that the network interface unit 820 can also be utilized to connect to other types of networks and remote computer systems.

It should be appreciated that the software components described herein, when loaded into the CPU 802 and executed, can transform the CPU 802 and the overall computing device 800 from a general-purpose computing device into a special-purpose computing device customized to facilitate the functionality presented herein. The CPU 802 can be constructed from any number of transistors or other discrete circuit elements, which can individually or collectively assume any number of states. More specifically, the CPU 802 can operate as a finite-state machine, in response to executable instructions contained within the software modules disclosed herein. These computer-executable instructions can transform the CPU 802 by specifying how the CPU 802 transitions between states, thereby transforming the transistors or other discrete hardware elements constituting the CPU 802.

The disclosure presented herein also encompasses the subject matter set forth in the following clauses.

Example Clause A, a system that correlates written feedback associated with a computer product to telemetry data associated with the computer product, comprising: a processing unit; and a computer-readable storage medium having computer-executable instructions stored thereupon, which, when executed by the processing unit, cause the processing unit to: apply a natural language processing model to a plurality of instances of written feedback associated with the computer product to identify a cluster of instances of written feedback, wherein: an individual instance of written feedback in the cluster of instances of written feedback is semantically similar to other instances of written feedback in the cluster of instances of written feedback; and the cluster of instances of written feedback is associated with an issue related to at least one of a performance or a reliability of the computer product; for an instance of written feedback in the cluster of instances of written feedback: extract an identification associated with at least one of a client computing device from which the instance of written feedback is submitted or an instance of the computer product from which the instance of written feedback is submitted; extract a timestamp associated with a time when the instance of written feedback is submitted; and retrieve, using the identification, a telemetry event log that includes telemetry events reported by the instance of the computer product during a period of time associated with the timestamp; analyze the telemetry event logs retrieved for the cluster of instances of written feedback to identify a common telemetry event that is found in a set of the telemetry event logs; identify meaningful instances of written feedback in the cluster of instances of written feedback that corresponds to the set of the telemetry event logs in which the common telemetry event is found; and provide the common telemetry event and the meaningful instances of written feedback to a computing device associated with a user tasked with examining the issue related to at least one of the performance or the reliability of the computer product.

Example Clause B, the system of Example Clause A, wherein the computer-executable instructions further cause the processing unit to: calculate a first hit ratio based on a number of the telemetry event logs in which the common telemetry event is found and a total number of the telemetry event logs retrieved for the cluster of instances of written feedback; calculate a second hit ratio based on a number of client computing devices for which the common telemetry event is found in respective telemetry data and a total number of the client computing devices from which the telemetry data is collected; compare the first hit ratio to the second hit ratio to determine a difference value; and determine that the difference value is greater than a threshold difference value established to indicate a significant correlation between the common telemetry event and the cluster of instances of written feedback, wherein the common telemetry event and the meaningful instances of written feedback are provided in response to determining that the difference value is greater than the threshold difference value.

Example Clause C, the system of Example Clause B, wherein: the common telemetry event is a first common telemetry event; the number of the telemetry event logs in which the first common telemetry event is found is a first number of the telemetry event logs; the meaningful instances of written feedback in the cluster of instances of written feedback that corresponds to the set of the telemetry event logs in which the first common telemetry event is found are first meaningful instances of written feedback; the number of the client computing devices for which the first common telemetry event is found in respective telemetry data is a first number of the client computing devices; the difference value is a first difference value; and the computer-executable instructions further cause the processing unit to: analyze the telemetry event logs retrieved for the cluster of instances of written feedback to identify a second common telemetry event that is found in a second set of the telemetry event logs; identify second meaningful instances of written feedback in the cluster of instances of written feedback that corresponds to the second set of the telemetry event logs in which the second common telemetry event is found; calculate a third hit ratio based on a second number of the telemetry event logs in which the second common telemetry event is found and the total number of the telemetry event logs retrieved for the cluster of instances of written feedback; calculate a fourth hit ratio based on a second number of the client computing devices for which the second common telemetry event is found in respective telemetry data and the total number of the client computing devices from which the telemetry data is collected; compare the third hit ratio to the fourth hit ratio to determine a second difference value; determine that the second difference value is greater than the threshold difference value; and provide, to the computing device associated with the user tasked with examining the issue related to at least one of the performance or the reliability of the computer product, the second meaningful instances of written feedback and a ranked order for the first common telemetry event and the second comment telemetry event, the ranked order based on the first difference value and the second difference value.

Example Clause D, the system of any one of Example Clauses A through C, wherein the period of time is a predefined time window before the time when the instance of written feedback is submitted.

Example Clause E, the system of any one of Example Clauses A through D, wherein providing the common telemetry event and the meaningful instances of written feedback to the computing device associated with the user tasked with examining the issue related to at least one of the performance or the reliability of the computer product comprises causing a display of a graphical user interface that presents the common telemetry event next to the meaningful instances of written feedback.

Example Clause F, the system of any one of Example Clauses A through E, wherein the computer-executable instructions further cause the processing unit to collect the telemetry data associated with the computer product from a plurality of client computing devices.

Example Clause G, the system of Example Clause F, wherein the computer-executable instructions further cause the processing unit to receive the plurality of instances of the written feedback associated with the computer product from a set of the plurality of client computing devices.

Example Clause H, the system of any one of Example Clauses A through G, wherein the computer product comprises an operating system.

Example Clause I, a method that correlates written feedback associated with a computer product to telemetry data associated with the computer product, comprising: applying a natural language processing model to a plurality of instances of written feedback associated with the computer product to identify a cluster of instances of written feedback, wherein: an individual instance of written feedback in the cluster of instances of written feedback is semantically similar to other instances of written feedback in the cluster of instances of written feedback; and the cluster of instances of written feedback is associated with an issue related to at least one of a performance or a reliability of the computer product; for an instance of written feedback in the cluster of instances of written feedback: extracting an identification associated with at least one of a client computing device from which the instance of written feedback is submitted or an instance of the computer product from which the instance of written feedback is submitted; extracting a timestamp associated with a time when the instance of written feedback is submitted; and retrieving, using the identification, a telemetry event log that includes telemetry events reported by the instance of the computer product during a period of time associated with the timestamp; analyzing the telemetry event logs retrieved for the cluster of instances of written feedback to identify a common telemetry event that is found in a set of the telemetry event logs; identifying meaningful instances of written feedback in the cluster of instances of written feedback that corresponds to the set of the telemetry event logs in which the common telemetry event is found; and providing the common telemetry event and the number of meaningful instances of written feedback to a computing device associated with a user tasked with examining the issue related to at least one of the performance or the reliability of the computer product.

Example Clause J, the method of Example Clause I, further comprising: calculating a first hit ratio based on a number of the telemetry event logs in which the common telemetry event is found and a total number of the telemetry event logs retrieved for the cluster of instances of written feedback; calculating a second hit ratio based on a number of client computing devices for which the common telemetry event is found in respective telemetry data and a total number of the client computing devices from which the telemetry data is collected; comparing the first hit ratio to the second hit ratio to determine a difference value; and determining that the difference value is greater than a threshold difference value established to indicate a significant correlation between the common telemetry event and the cluster of instances of written feedback, wherein the common telemetry event and the number of meaningful instances of written feedback are provided in response to determining that the difference value is greater than the threshold difference value.

Example Clause K, the method of Example Clause J, wherein: the common telemetry event is a first common telemetry event; the number of the telemetry event logs in which the first common telemetry event is found is a first number of the telemetry event logs; the meaningful instances of written feedback in the cluster of instances of written feedback that corresponds to the number of the telemetry event logs in which the first common telemetry event is found are first meaningful instances of written feedback; the number of the client computing devices for which the first common telemetry event is found in respective telemetry data is a first number of the client computing devices; the difference value is a first difference value; and the method further comprises: analyzing the telemetry event logs retrieved for the cluster of instances of written feedback to identify a second common telemetry event that is found in a second set of the telemetry event logs; identifying second meaningful instances of written feedback in the cluster of instances of written feedback that corresponds to the second set of the telemetry event logs in which the second common telemetry event is found; calculating a third hit ratio based on a second number of the telemetry event logs in which the second common telemetry event is found and the total number of the telemetry event logs retrieved for the cluster of instances of written feedback; calculating a fourth hit ratio based on a second number of the client computing devices for which the second common telemetry event is found in respective telemetry data and the total number of the client computing devices from which the telemetry data is collected; comparing the third hit ratio to the fourth hit ratio to determine a second difference value; determining that the second difference value is greater than the threshold difference value; and providing, to the computing device associated with the user tasked with examining the issue related to at least one of the performance or the reliability of the computer product, the second meaningful instances of written feedback and a ranked order for the first common telemetry event and the second comment telemetry event, the ranked order based on the first difference value and the second difference value.

Example Clause L, the method of any one of Example Clauses I through K, wherein the period of time is a predefined time window before the time when the instance of written feedback is submitted.

Example Clause M, the method of any one of Example Clauses I through L, wherein providing the common telemetry event and the meaningful instances of written feedback to the computing device associated with the user tasked with examining the issue related to at least one of the performance or the reliability of the computer product comprises causing a display of a graphical user interface that presents the common telemetry event next to the meaningful instances of written feedback.

Example Clause N, the method of any one of Example Clauses I through M, further comprising collecting the telemetry data associated with the computer product from a plurality of client computing devices.

Example Clause O, the method of Example Clause N, further comprising receiving the plurality of instances of the written feedback associated with the computer product from a set of the plurality of client computing devices.

Example Clause P, the method of any one of Example Clauses I through O, wherein the computer product comprises an operating system.

Example Clause Q, a computer-readable storage medium having encoded thereon computer-readable instructions that when executed by a processing unit causes a system to: apply a natural language processing model to a plurality of instances of written feedback associated with the computer product to identify a cluster of instances of written feedback, wherein: an individual instance of written feedback in the cluster of instances of written feedback is semantically similar to other instances of written feedback in the cluster of instances of written feedback; and the cluster of instances of written feedback is associated with an issue related to at least one of a performance or a reliability of the computer product; for an instance of written feedback in the cluster of instances of written feedback: extract an identification associated with at least one of a client computing device from which the instance of written feedback is submitted or an instance of the computer product from which the instance of written feedback is submitted; extract a timestamp associated with a time when the instance of written feedback is submitted; and retrieve, using the identification, a telemetry event log that includes telemetry events reported by the version of the computer product during a period of time associated with the timestamp; analyze the telemetry event logs retrieved for the cluster of instances of written feedback to identify a common telemetry event that is found in a set of the telemetry event logs; identify meaningful instances of written feedback in the cluster of instances of written feedback that corresponds to the set of the telemetry event logs in which the common telemetry event is found; and provide the common telemetry event and the meaningful instances of written feedback to a computing device associated with a user tasked with examining the issue related to at least one of the performance or the reliability of the computer product.

Example Clause R, the computer-readable storage medium of Example Clause Q, wherein the computer-readable instructions further cause the system to: calculate a first hit ratio based on a number of the telemetry event logs in which the common telemetry event is found and a total number of the telemetry event logs retrieved for the cluster of instances of written feedback; calculate a second hit ratio based on a number of client computing devices for which the common telemetry event is found in respective telemetry data and a total number of the client computing devices from which the telemetry data is collected; compare the first hit ratio to the second hit ratio to determine a difference value; and determine that the difference value is greater than a threshold difference value established to indicate a significant correlation between the common telemetry event and the cluster of instances of written feedback, wherein the common telemetry event and the meaningful instances of written feedback are provided in response to determining that the difference value is greater than the threshold difference value.

Example Clause S, the computer-readable storage medium of Example Clause R, wherein: the common telemetry event is a first common telemetry event; the number of the telemetry event logs in which the first common telemetry event is found is a first number of the telemetry event logs; the meaningful instances of written feedback in the cluster of instances of written feedback that corresponds to the set of the telemetry event logs in which the first common telemetry event is found are first meaningful instances of written feedback; the number of the client computing devices for which the first common telemetry event is found in respective telemetry data is a first number of the client computing devices; the difference value is a first difference value; and the computer-readable instructions further cause the system to: analyze the telemetry event logs retrieved for the cluster of instances of written feedback to identify a second common telemetry event that is found in a second set of the telemetry event logs; identify second meaningful instances of written feedback in the cluster of instances of written feedback that corresponds to the second set of the telemetry event logs in which the second common telemetry event is found; calculate a third hit ratio based on a second number of the telemetry event logs in which the second common telemetry event is found and the total number of the telemetry event logs retrieved for the cluster of instances of written feedback; calculate a fourth hit ratio based on a second number of the client computing devices for which the second common telemetry event is found in respective telemetry data and the total number of the client computing devices from which the telemetry data is collected; compare the third hit ratio to the fourth hit ratio to determine a second difference value; determine that the second difference value is greater than the threshold difference value; and provide, to the computing device associated with the user tasked with examining the issue related to at least one of the performance or the reliability of the computer product, the second meaningful instances of written feedback and a ranked order for the first common telemetry event and the second comment telemetry event, the ranked order based on the first difference value and the second difference value.

Example Clause T, the computer-readable storage medium of any one of Example Clauses Q through S, wherein the period of time is a predefined time window before the time when the instance of written feedback is submitted.

Encoding the software modules presented herein also may transform the physical structure of the computer-readable media presented herein. The specific transformation of physical structure may depend on various factors, in different implementations of this description. Examples of such factors may include, but are not limited to, the technology used to implement the computer-readable media, whether the computer-readable media is characterized as primary or secondary storage, and the like. For example, if the computer-readable media is implemented as semiconductor-based memory, the software disclosed herein may be encoded on the computer-readable media by transforming the physical state of the semiconductor memory. For example, the software may transform the state of transistors, capacitors, or other discrete circuit elements constituting the semiconductor memory. The software also may transform the physical state of such components in order to store data thereupon.

Conditional language such as, among others, “can,” “could,” “might” or “may,” unless specifically stated otherwise, are understood within the context to present that certain examples include, while other examples do not include, certain features, elements and/or steps. Thus, such conditional language is not generally intended to imply that certain features, elements and/or steps are in any way required for one or more examples or that one or more examples necessarily include logic for deciding, with or without user input or prompting, whether certain features, elements and/or steps are included or are to be performed in any particular example. Conjunctive language such as the phrase “at least one of X, Y or Z,” unless specifically stated otherwise, is to be understood to present that an item, term, etc. may be either X, Y, or Z, or a combination thereof.

The terms “a,” “an,” “the” and similar referents used in the context of describing the invention (especially in the context of the following claims) are to be construed to cover both the singular and the plural unless otherwise indicated herein or clearly contradicted by context. The terms “based on,” “based upon,” and similar referents are to be construed as meaning “based at least in part” which includes being “based in part” and “based in whole” unless otherwise indicated or clearly contradicted by context.

It should be appreciated that any reference to “first,” “second,” etc. elements within the Summary and/or Detailed Description is not intended to and should not be construed to necessarily correspond to any reference of “first,” “second,” etc. elements of the claims. Rather, any use of “first” and “second” within the Summary, Detailed Description, and/or claims may be used to distinguish between two different instances of the same element (e.g., two different instances of written feedback, two different hit ratios, etc.).

In closing, although the various configurations have been described in language specific to structural features and/or methodological acts, it is to be understood that the subject matter defined in the appended representations is not necessarily limited to the specific features or acts described. Rather, the specific features and acts are disclosed as example forms of implementing the claimed subject matter. All examples are provided for illustrative purposes and is not to be construed as limiting.

What is claimed is:

1. A system that correlates written feedback associated with a computer product to telemetry data associated with the computer product, comprising:
a processing unit; and
a computer-readable storage medium having computer-executable instructions stored thereupon, which, when executed by the processing unit, cause the processing unit to:
apply a natural language processing model to a plurality of instances of written feedback associated with the computer product to identify a cluster of instances of written feedback, wherein:
an individual instance of written feedback in the cluster of instances of written feedback is semantically similar to other instances of written feedback in the cluster of instances of written feedback; and
the cluster of instances of written feedback is associated with an issue related to at least one of a performance or a reliability of the computer product;
for an instance of written feedback in the cluster of instances of written feedback:
extract an identification associated with at least one of a client computing device from which the instance of written feedback is submitted or an instance of the computer product from which the instance of written feedback is submitted;
extract a timestamp associated with a time when the instance of written feedback is submitted; and
retrieve, using the identification, a telemetry event log that includes telemetry events reported by the instance of the computer product during a period of time associated with the timestamp;
analyze the telemetry event logs retrieved for the cluster of instances of written feedback to identify a common telemetry event that is found in a set of the telemetry event logs;
identify meaningful instances of written feedback in the cluster of instances of written feedback that corresponds to the set of the telemetry event logs in which the common telemetry event is found; and
provide the common telemetry event and the meaningful instances of written feedback to a computing device associated with a user tasked with examining the issue related to at least one of the performance or the reliability of the computer product.

2. The system of claim 1, wherein the computer-executable instructions further cause the processing unit to:
calculate a first hit ratio based on a number of the telemetry event logs in which the common telemetry event is found and a total number of the telemetry event logs retrieved for the cluster of instances of written feedback;
calculate a second hit ratio based on a number of client computing devices for which the common telemetry event is found in respective telemetry data and a total number of the client computing devices from which the telemetry data is collected;
compare the first hit ratio to the second hit ratio to determine a difference value; and
determine that the difference value is greater than a threshold difference value established to indicate a significant correlation between the common telemetry event and the cluster of instances of written feedback, wherein the common telemetry event and the meaningful instances of written feedback are provided in response to determining that the difference value is greater than the threshold difference value.

3. The system of claim 2, wherein:
the common telemetry event is a first common telemetry event;
the number of the telemetry event logs in which the first common telemetry event is found is a first number of the telemetry event logs;
the meaningful instances of written feedback in the cluster of instances of written feedback that corresponds to the set of the telemetry event logs in which the first common telemetry event is found are first meaningful instances of written feedback;
the number of the client computing devices for which the first common telemetry event is found in respective telemetry data is a first number of the client computing devices;
the difference value is a first difference value; and
the computer-executable instructions further cause the processing unit to:
analyze the telemetry event logs retrieved for the cluster of instances of written feedback to identify a second common telemetry event that is found in a second set of the telemetry event logs;
identify second meaningful instances of written feedback in the cluster of instances of written feedback that corresponds to the second set of the telemetry event logs in which the second common telemetry event is found;
calculate a third hit ratio based on a second number of the telemetry event logs in which the second common telemetry event is found and the total number of the telemetry event logs retrieved for the cluster of instances of written feedback;
calculate a fourth hit ratio based on a second number of the client computing devices for which the second common telemetry event is found in respective telemetry data and the total number of the client computing devices from which the telemetry data is collected;
compare the third hit ratio to the fourth hit ratio to determine a second difference value;
determine that the second difference value is greater than the threshold difference value; and
provide, to the computing device associated with the user tasked with examining the issue related to at least one of the performance or the reliability of the computer product, the second meaningful instances of written feedback and a ranked order for the first common telemetry event and the second comment telemetry event, the ranked order based on the first difference value and the second difference value.

4. The system of claim 1, wherein the period of time is a predefined time window before the time when the instance of written feedback is submitted.

5. The system of claim 1, wherein providing the common telemetry event and the meaningful instances of written feedback to the computing device associated with the user tasked with examining the issue related to at least one of the performance or the reliability of the computer product comprises causing a display of a graphical user interface that presents the common telemetry event next to the meaningful instances of written feedback.

6. The system of claim 1, wherein the computer-executable instructions further cause the processing unit to collect the telemetry data associated with the computer product from a plurality of client computing devices.

7. The system of claim 6, wherein the computer-executable instructions further cause the processing unit to receive the plurality of instances of the written feedback associated with the computer product from a set of the plurality of client computing devices.

8. The system of claim 1, wherein the computer product comprises an operating system.

9. A method that correlates written feedback associated with a computer product to telemetry data associated with the computer product, comprising:
applying a natural language processing model to a plurality of instances of written feedback associated with the computer product to identify a cluster of instances of written feedback, wherein:
an individual instance of written feedback in the cluster of instances of written feedback is semantically similar to other instances of written feedback in the cluster of instances of written feedback; and
the cluster of instances of written feedback is associated with an issue related to at least one of a performance or a reliability of the computer product;
for an instance of written feedback in the cluster of instances of written feedback:
extracting an identification associated with at least one of a client computing device from which the instance of written feedback is submitted or an instance of the computer product from which the instance of written feedback is submitted;
extracting a timestamp associated with a time when the instance of written feedback is submitted; and
retrieving, using the identification, a telemetry event log that includes telemetry events reported by the instance of the computer product during a period of time associated with the timestamp;
analyzing the telemetry event logs retrieved for the cluster of instances of written feedback to identify a common telemetry event that is found in a set of the telemetry event logs;
identifying meaningful instances of written feedback in the cluster of instances of written feedback that corresponds to the set of the telemetry event logs in which the common telemetry event is found; and
providing the common telemetry event and the number of meaningful instances of written feedback to a computing device associated with a user tasked with examining the issue related to at least one of the performance or the reliability of the computer product.

10. The method of claim 9, further comprising:
calculating a first hit ratio based on a number of the telemetry event logs in which the common telemetry event is found and a total number of the telemetry event logs retrieved for the cluster of instances of written feedback;
calculating a second hit ratio based on a number of client computing devices for which the common telemetry event is found in respective telemetry data and a total number of the client computing devices from which the telemetry data is collected;
comparing the first hit ratio to the second hit ratio to determine a difference value; and
determining that the difference value is greater than a threshold difference value established to indicate a significant correlation between the common telemetry event and the cluster of instances of written feedback, wherein the common telemetry event and the number of meaningful instances of written feedback are provided in response to determining that the difference value is greater than the threshold difference value.

11. The method of claim 10, wherein:
the common telemetry event is a first common telemetry event;
the number of the telemetry event logs in which the first common telemetry event is found is a first number of the telemetry event logs;
the meaningful instances of written feedback in the cluster of instances of written feedback that corresponds to the number of the telemetry event logs in which the first common telemetry event is found are first meaningful instances of written feedback;
the number of the client computing devices for which the first common telemetry event is found in respective telemetry data is a first number of the client computing devices;
the difference value is a first difference value; and
the method further comprises:
analyzing the telemetry event logs retrieved for the cluster of instances of written feedback to identify a second common telemetry event that is found in a second set of the telemetry event logs;
identifying second meaningful instances of written feedback in the cluster of instances of written feedback that corresponds to the second set of the telemetry event logs in which the second common telemetry event is found;
calculating a third hit ratio based on a second number of the telemetry event logs in which the second common telemetry event is found and the total number of the telemetry event logs retrieved for the cluster of instances of written feedback;
calculating a fourth hit ratio based on a second number of the client computing devices for which the second common telemetry event is found in respective telemetry data and the total number of the client computing devices from which the telemetry data is collected;
comparing the third hit ratio to the fourth hit ratio to determine a second difference value;
determining that the second difference value is greater than the threshold difference value; and
providing, to the computing device associated with the user tasked with examining the issue related to at least one of the performance or the reliability of the computer product, the second meaningful instances of written feedback and a ranked order for the first common telemetry event and the second comment telemetry event, the ranked order based on the first difference value and the second difference value.

12. The method of claim 9, wherein the period of time is a predefined time window before the time when the instance of written feedback is submitted.

13. The method of claim 9, wherein providing the common telemetry event and the meaningful instances of written feedback to the computing device associated with the user tasked with examining the issue related to at least one of the performance or the reliability of the computer product comprises causing a display of a graphical user interface that presents the common telemetry event next to the meaningful instances of written feedback.

14. The method of claim 9, further comprising collecting the telemetry data associated with the computer product from a plurality of client computing devices.

15. The method of claim 14, further comprising receiving the plurality of instances of the written feedback associated with the computer product from a set of the plurality of client computing devices.

16. The method of claim 9, wherein the computer product comprises an operating system.

17. A computer-readable storage medium having encoded thereon computer-readable instructions that when executed by a processing unit causes a system to:
apply a natural language processing model to a plurality of instances of written feedback associated with the computer product to identify a cluster of instances of written feedback, wherein:
an individual instance of written feedback in the cluster of instances of written feedback is semantically similar to other instances of written feedback in the cluster of instances of written feedback; and
the cluster of instances of written feedback is associated with an issue related to at least one of a performance or a reliability of the computer product;
for an instance of written feedback in the cluster of instances of written feedback:
extract an identification associated with at least one of a client computing device from which the instance of written feedback is submitted or an instance of the computer product from which the instance of written feedback is submitted;
extract a timestamp associated with a time when the instance of written feedback is submitted; and
retrieve, using the identification, a telemetry event log that includes telemetry events reported by the version of the computer product during a period of time associated with the timestamp;
analyze the telemetry event logs retrieved for the cluster of instances of written feedback to identify a common telemetry event that is found in a set of the telemetry event logs;
identify meaningful instances of written feedback in the cluster of instances of written feedback that corresponds to the set of the telemetry event logs in which the common telemetry event is found; and
provide the common telemetry event and the meaningful instances of written feedback to a computing device associated with a user tasked with examining the issue related to at least one of the performance or the reliability of the computer product.

18. The computer-readable storage medium of claim 17, wherein the computer-readable instructions further cause the system to:
calculate a first hit ratio based on a number of the telemetry event logs in which the common telemetry event is found and a total number of the telemetry event logs retrieved for the cluster of instances of written feedback;
calculate a second hit ratio based on a number of client computing devices for which the common telemetry event is found in respective telemetry data and a total number of the client computing devices from which the telemetry data is collected;
compare the first hit ratio to the second hit ratio to determine a difference value; and
determine that the difference value is greater than a threshold difference value established to indicate a significant correlation between the common telemetry event and the cluster of instances of written feedback, wherein the common telemetry event and the meaningful instances of written feedback are provided in response to determining that the difference value is greater than the threshold difference value.

19. The computer-readable storage medium of claim 18, wherein:
the common telemetry event is a first common telemetry event;
the number of the telemetry event logs in which the first common telemetry event is found is a first number of the telemetry event logs;
the meaningful instances of written feedback in the cluster of instances of written feedback that corresponds to the set of the telemetry event logs in which the first common telemetry event is found are first meaningful instances of written feedback;
the number of the client computing devices for which the first common telemetry event is found in respective telemetry data is a first number of the client computing devices;
the difference value is a first difference value; and
the computer-readable instructions further cause the system to:
analyze the telemetry event logs retrieved for the cluster of instances of written feedback to identify a second common telemetry event that is found in a second set of the telemetry event logs;
identify second meaningful instances of written feedback in the cluster of instances of written feedback that corresponds to the second set of the telemetry event logs in which the second common telemetry event is found;
calculate a third hit ratio based on a second number of the telemetry event logs in which the second common telemetry event is found and the total number of the telemetry event logs retrieved for the cluster of instances of written feedback;
calculate a fourth hit ratio based on a second number of the client computing devices for which the second common telemetry event is found in respective telemetry data and the total number of the client computing devices from which the telemetry data is collected;
compare the third hit ratio to the fourth hit ratio to determine a second difference value;
determine that the second difference value is greater than the threshold difference value; and
provide, to the computing device associated with the user tasked with examining the issue related to at least one of the performance or the reliability of the computer product, the second meaningful instances of written feedback and a ranked order for the first common telemetry event and the second comment telemetry event, the ranked order based on the first difference value and the second difference value.

20. The computer-readable storage medium of claim 17, wherein the period of time is a predefined time window before the time when the instance of written feedback is submitted.
